(19) United States
(12) Patent Application Publication
(10) Pub. No.: US 2017/0325400 A1
(43) Pub. Date: Nov. 16, 2017

(54) METHOD FOR NAVIGATION AND JOINT COORDINATION OF AUTOMATED DEVICES

(71) Applicant: Ariel Scientific Innovations Ltd, Ariel (IL)

(72) Inventors: Oleg Yurjevich Kupervasser, Moscow (RU); Yury Iljich Kupervasser, Moscow (RU); Alexander Alexandrovich Rubinstein, Moscow (RU)

(21) Appl. No.: 15/607,501

(22) Filed: May 28, 2017

Related U.S. Application Data
(63) Continuation-in-part of application No. 14/700,180, filed on Apr. 30, 2015, now abandoned.
Application No. 14/700,180 is a continuation of application No. PCT/RU2013/000983, filed on Nov. 7, 2013.
Application No. PCT/RU2013/000983 is a continuation of application No. PCT/RU2013/000984, filed on Nov. 7, 2013.

(30) Foreign Application Priority Data
Nov. 12, 2012 (RU) 2012147923
Nov. 12, 2012 (RU) 2012147924

(51) Int. Cl. A01D 34/00; G01C 21/00; G05D 1/02; G01S 19/14; G05D 1/00; A01D 101/00

(52) U.S. Cl. CPC A01D 34/008; G05D 1/0027; G01C 21/00; G05D 1/0291; G05D 1/0278; G01S 19/14; A01D 2101/00; G05D 2201/0208

(57) ABSTRACT

The invention relates to methods for controlling automated devices. The method comprises locating at least one automated device on an area being controlled and placing an observation device, before the automated device starts operation, over the area being controlled on a flying device or tower, said observation device being capable of receiving and transmitting a control signal to the automated device and determining the coordinates of the flying device, whereupon said observation device controls at least said one automated device. The invention simplifies control of the automated device and improves the accuracy with which its coordinates are determined.

### CROSS-REFERENCE TO RELATED APPLICATIONS

This application is a continuation-in-part of U.S. Ser. No. 14/700,180 which is included by reference as if fully set-forth herein. This application is also a continuation of International Application No. PCT/RU2013/000984 filed on Nov. 7, 2013, which claims benefit of priority to Russian Application No. 2012147923 filed on Nov. 12, 2012, both of which are incorporated by reference herein. This application is also a continuation of International Application No. PCT/RU2013/000983 filed on Nov. 7, 2013, which claims benefit of priority to Russian Application No. 2012147924, filed on Nov. 12, 2012, both of which are incorporated by reference herein.

### FIELD OF THE TECHNOLOGY

The invention relates to methods for controlling automated devices and can be used for coordinating robot-controlled gardening machines, for example, lawn mowers.

### BACKGROUND

Absence of an inexpensive and reliable navigation system and lack of mutual coordination of operations are among the basic problems of video navigation, coordination, and control of robotized lawn mowers.

For example, to prevent a robot-controlled lawn mower from running beyond the grass mowing area, a wire must used to encircle the area. The navigation system of a majority of commercial robots can only have them roam randomly, see:
http://www.therobotreport.com/news/robot-lawnmowers-still-a-work-in-progress.

Systems of infrared fences or marks have been developed lately. A system of ground radio beacons can also be used. These types of systems, however, are very expensive and complicated.

The most recent developments are advanced DGPS-based systems. DGPS is the best choice because the common GPS does not assure sufficient accuracy of positioning. This most advanced system is not without problems either. First, the GPS signal may be screened near houses, or be reflected several times, or suppressed by disturbances or deliberately. As a result, robot coordination is disrupted. Second, the coordinates of the lawn boundary have to be measured and entered into the robot, a hard effort to accomplish. Third, DGPS provides the coordinates, rather than robot orientation. Fourth, the system is adjusted to abstract coordinates, rather than the real setting of the robot. For example, the robot does not detect a stationary or moving obstacle (a dog or child). Fifth, DGPS does not recognize if there is grass to be mowed on the lawn or not. Sixth, DGPS has difficulty organizing mutual coordination of the robots that are unaware of their mutual position and must be equipped with a complicated system for mutual detection and exchange of signals. Seventh, this system is expensive.

Many of these problems could be solved by a video navigator fitted on the robot. This would create more problems—the video navigator has a limited field of vision that can only be expanded by providing a large number of cameras or cameras having a wide field of vision. This is a complicated and costly undertaking. Besides, many complicated ground marks are to be set up and be well distinguished. Natural landmarks are not always distinguished well. The area to be mowed certainly has to be provided with ground marks. And again, it is difficult to coordinate robots among themselves.

### BRIEF DESCRIPTION OF THE FIGURE

Some embodiments of the invention are described herein with reference to the accompanying FIGURE. The description, together with the FIGURE, makes apparent to a person having ordinary skill in the art how some embodiments of the invention may be practiced. The FIGURE is for the purpose of illustrative discussion and no attempt is made to show structural details of an embodiment in more detail than is necessary for a fundamental understanding of the invention. For the sake of clarity, some objects depicted in the FIGURE are not to scale.

In the FIGURE:

FIG. 1 depicts an embodiment of the teachings herein.

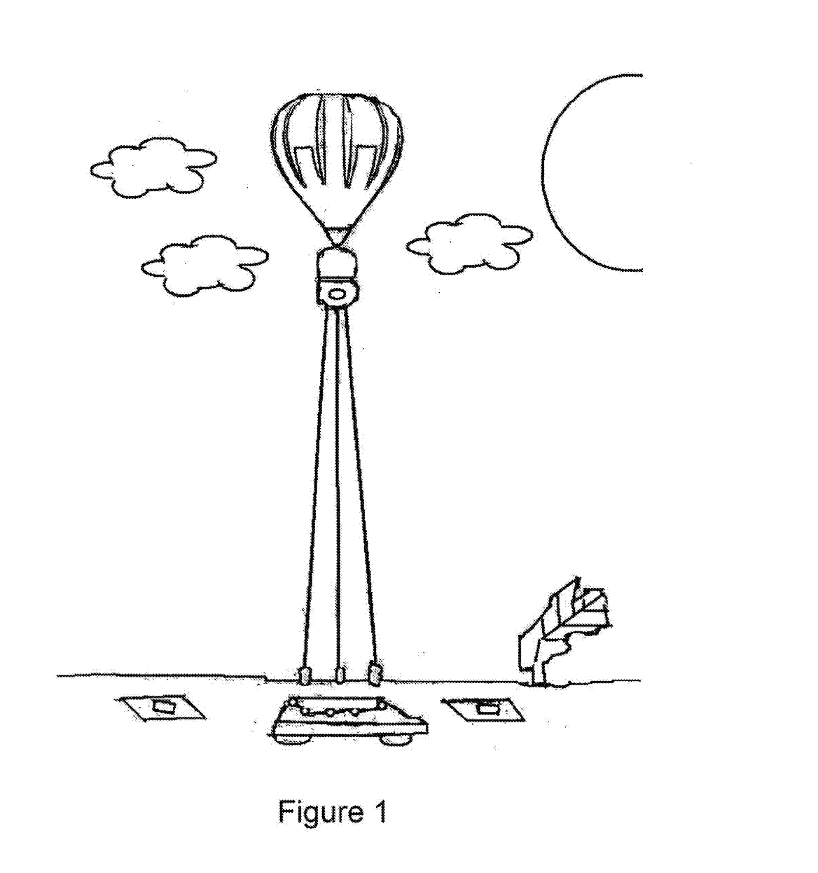

### DESCRIPTION OF INVENTION

This invention is intended to solve these problems and eliminate the deficiencies referred to above.

This invention, if used as herein described, simplifies control of an automated device and improves the accuracy with which its coordinates are determined.

This technical result is achieved in the claimed method for navigation and joint coordination of automated devices, said method comprising placing at least one automated device on the area being controlled such that, according to the invention, an observation apparatus is located, before the start of operation of the automated device, above the area being controlled on a flying device or put up on a tower, said apparatus being capable of receiving and transmitting a control signal to the automated device and being also capable of determining the coordinates of the flying devices, said apparatus being thereafter used to control at least one automated device.

According to an aspect of some embodiments, there is provided, a method for navigation and joint coordination of automated devices, placed at an area being controlled, by developing routing for every automated device according to information about coordinates of obstacles, boundaries of a treated area, boundaries of the controlled area, which are defined by an user by drawing boundaries of the controlled area on image of the controlled area, and coordinates of all automated devices on the controlled area, whose distinctive features are that for making possible operation of automated devices on the controlled area, mainly on the parts of the controlled area, where a signal from GPS satellites is screened or rerefracted, before the automated devices start to operate over the area being controlled, an observation device is positioned on a flying device or on a tower or on a tethered observation platform for tracking the automated devices on the area being controlled and observation of its environment, including natural and artificial landmark, said observation device being capable of transmitting to the at least one automated device information about the area being controlled and objects on this area, the at least on one automated device this information is processed for calculation of coordinates of the observation device, coordinates of all automated devices on the controlled area, coordinates of obstacles, boundaries of a treated area, boundaries of the controlled area, verification that automated devices do not pass boundary of the controlled area, drawn by the user on the image of the controlled area, and also exchange by control signals is possible between automated devices and observation device for joint coordination.

In some embodiments a distinctive feature of the method for navigation and joint coordination is that calculation of coordinates of obstacles, boundaries of a treated area, boundaries of the controlled area, and coordinates of all automated devices on the controlled area from observation device's information about the area being controlled and objects on this area, is processed on the observation device.

In some embodiments a distinctive feature of the method for navigation and joint coordination is that calculation of coordinates of obstacles, boundaries of a treated area, boundaries of the controlled area, and coordinates of all automated devices on the controlled area from observation device's information about the area being controlled and objects on this area, is processed on unmoving post, and also exchange by control signals and information between automated devices, observation device, and unmoving post is possible, and also automated devices can get energy charge from unmoving post.

In some embodiments a distinctive feature of the method for navigation and joint coordination is that observation device can be initially placed on the ground, on one from automated device, or on unmoving post, and after beginning of automated device's operation can fly up, fly, fly down on the towers tier convenience of automated device's tracking on the controlled area.

In some embodiments a distinctive feature of the method for navigation and joint coordination is that the system is possible to recognize and find coordinates of dangerous moving objects such as children or animals.

The invention is illustrated in the drawing showing one of possible embodiments of the claimed method. The drawing illustrates an air sonde carrying a camera; marks on the ground and on the robot-controlled lawn mower; and a natural reference point such as a bush.

The claimed method is performed as follows: first, at least one automated device (a robot-controlled lawn mower) is located on the area (lawn) being controlled. Before the automated device starts operation, a tracking device (such as a camera) is positioned above the area being controlled on a flying device such as a sonde balloon or a pilotless vehicle of helicopter type, or said device can be positioned on a tower of a height allowing the entire area being controlled to be viewed. The device is capable of receiving and transmitting a control signal from and to the automated device and also of determining the coordinates of the flying device. The device also can exchange signals, including RF signals, with the robots. The camera observes the robot and determines its position relative to itself. Marks distinguished easily from above can be placed on the robot and its charging device. If several robots are used, their mutual coordination is easy enough—the camera sees them all at a time, and a computer system receiving data from the camera coordinates their mutual movement easily. The boundaries of the area to be mowed by a robot-controlled lawn mower can be drawn on the computer system screen by the mouse pointer, or by a sensor pencil, or a finger on the screen.

Furthermore, a visible signal can be replaced with other regions of the spectrum. The signal received can be both natural and generated by the robot or device on the camera, or at any other point of the area. Equally suitable are sound, smell or chemical signals, or radioactivity slightly above the background level (for example, silicon plates).

The system can easily see obstacles or moving objects and determine the extent and quality of grass mowing. It is simple in design and has a low cost.

The claimed system can be used with a broad class of robots: automated lawn mowers, robotized room cleaners, tractors, snowplows, garbage collectors, street cleaners, vehicles for transporting people and freight, and even extraterrestrial robots on other planets, for example, on Mars.

The system fits easily into the framework of an “intelligent” home, or even an “intelligent” city, being capable of coordinating many actions, robots, and objects at a time, and performing several tasks simultaneously, for example, navigation and recognition.

The invention has been disclosed above with reference to a specific embodiment thereof. Other embodiments that do not depart from the idea of the invention as it is disclosed herein may be obvious to people skilled in the art. Accordingly, the description of the invention may be considered limited in scope by the following claim only.

1-5. (canceled)

6. A method for controlling at least one automated device in a working area, the method comprising:
positioning at least one controlling device including at least one imaging mechanism above said working area, such that a field of view of said at least one imaging mechanism includes the entirety of said working area;
initiating operation of said at least one automated device in said working area; and
during operation of said at least one automated device in said working area:
using said at least one imaging mechanism, capturing images of said working area; and
based on said captured images of said working area, providing at least one control signal from said at least one controlling device to said at least one automated device, at least for ensuring that said at least one automated device remains within said working area and does not coincide with obstacles in said working area.

7. The method of claim 6, wherein said providing control signals comprises, at said at least one controlling device and based on said images, determining a position of said at least one automated device relative to a position of said at least one controlling device, and providing directional control signals to said at least one automated device based on said position of said at least one automated device.

8. The method of claim 7, wherein said determining a position of said at least one automated device includes determining said position based on at least one landmark visible in at least one of said images.

9. The method of claim 7, wherein at least one automated device has at least one visual mark on an exterior of a body thereof, and wherein said determining a position of said at least one automated device includes determining said position based on identification of said at least one visual mark in at least one of said images.

10. The method of claim 7, further comprising placing at least one marker in a known location in said working area, and wherein said determining a position of said at least one automated device includes determining said position based on identification of said at least one marker.

11. The method of claim 6, further comprising:
receiving input from a user, said input including a delimitation of boundaries of said working area on an image of an area including said working area;
based on said input, providing to said at least controlling device information identifying said boundaries of said working area.

12. The method of claim 6, wherein said providing at least one control signal comprises providing at least one of:
a signal identifying a direction in which said at least one automated device should move;
a signal pausing or terminating operation of said at least one automated device;
a signal stopping motion of said at least one automated device; and
a signal instructing said at least one automated device to return to a docking or charging station.

13. The method of claim 6, wherein said obstacles in said working area include at least one of:
inanimate objects;
animals;
people; and
another automated device.

14. The method of claim 6, wherein said at least one automated device comprises a plurality of automated device, and wherein said providing at least one control signal comprises providing at least one control signal to each of said plurality of automated devices.

15. The method of claim 6, wherein said positioning at least one controlling device comprises at least one of:
mounting said at least one controlling device on a grounded airborne device and deploying said airborne device above said working area; and
mounting said at least one controlling device in an elevated location at a height allowing said field of view.

16. A device for controlling at least one automated device in a working area, the device comprising:
at least one imaging mechanism, such that a field of view of said at least one imaging mechanism includes the entirety of said working area;
at least one signal transmitter configured to transmit at least one control signal to said at least one automated device in said working area; and
a processor configure to:
receive images of said working area captured by said at least one image capturing mechanism;
based on said received images, generate at least one control signal, at least for ensuring that said at least one automated device remains within said working area and does not coincide with obstacles in said working area; and
provide said at least one control signal to said signal transmitter for transmission to said at least one automated device.

17. The device of claim 16, wherein said processor is configured to generate said at least one control signal by determining a position of said at least one automated device relative to a position of said device, and generating a directional control signal for said at least one automated device based on said position of said at least one automated device.

18. The device of claim 17, wherein said processor is configured to determine said position of said at least one automated device based on at least one landmark visible in at least one of said images.

19. The device of claim 17, wherein at least one automated device has at least one visual mark on an exterior of a body thereof, and wherein said processor is configured to determine said position of said at least one automated device based on identification of said at least one visual mark in at least one of said images.

20. The device of claim 17, wherein said working area includes at least one marker placed in a known location therein, and wherein said processor is configured to determine said position of said at least one automated device based on identification of said at least one marker.

21. The device of claim 16, wherein said processor is further configure to receive input from a user, said input including a delimitation of boundaries of said working area on an image of an area including said working area; and
based on said input, to determine boundaries for a location of said at least one automated device in said working area.

22. The device of claim 16, wherein said at least one control signal comprises at least one of:
a signal identifying a direction in which said at least one automated device should move;
a signal pausing or terminating operation of said at least one automated device;
a signal stopping motion of said at least one automated device; and
a signal instructing said at least one automated device to return to a docking or charging station.

23. The device of claim 16, wherein said obstacles in said working area include at least one of:
inanimate objects;
animals;
people; and
another automated device.

24. The device of claim 16, wherein said at least one automated device comprises a plurality of automated device, and wherein processor is configured to generate at least one control signal for each of said plurality of automated devices.

25. The device of claim 16, wherein said device is mounted onto at least one of:
an airborne device deployed above said working area; and
an elevated location on the ground, such that at a height of said device on said elevated location enables said field of view.
